(19) United States
(12) Patent Application Publication
(10) Pub. No.: US 2007/0163833 A1
(43) Pub. Date: Jul. 19, 2007

(54) Steering system for a vehicle

(76) Inventors: Walter Kogel, Abtsgmund (DE); Michael Hagele, Aalen (DE)

Correspondence Address: KENYON & KENYON LLP, ONE BROADWAY, NEW YORK, NY, 10004, US

(21) Appl. No.: 10/589,426

(22) PCT Filed: Aug. 25, 2005
(86) PCT No.: PCT/EP05/50513

§ 371 Date: Aug. 14, 2006

(30) Foreign Application Priority Data
Feb. 12, 2004 (DE) 102004006835

(51) Int. Cl. B62D 5/00

(52) U.S. Cl. 180/405; 180/443; 180/417

(57) ABSTRACT

A steering system for a vehicle, e.g., a hydraulically assisted power-steering system for a motor vehicle, includes a steering spindle that connects a steering handle on its one end to a rotary slide valve or rotary pistons of a steering valve via a first torsion element. The steering system has a hydraulic servomotor for actuating an output member of a steering gear, a flow of pressurized media into working chambers of the hydraulic servomotor being controlled by the steering valve. The steering system additionally has an electric servomotor for actuating the output member. In order to provide a steering system, whose hydraulic servomotor is assisted, during operation, both mechanically by a steering handle and by an electric servomotor and is fail-safe, it is provided that the electric servomotor and the steering spindle act upon a common rotating member between the first torsion element and the rotary slide valve or rotary piston.

### FIELD OF THE INVENTION

The present invention relates to a steering system for a vehicle, e.g., a hydraulically assisted power-steering system for a motor vehicle.

### BACKGROUND INFORMATION

Various arrangements of power-steering systems are conventional, which have a superposition function for superposing the actuating torque applied to a steering handle and a torque of a servomotor. For reasons of redundancy, the power-steering systems may also be manufactured to have a plurality of servomotors of the same construction type (cf., German Published Patent Application No. 29 18 975) or different construction type, such as a hydraulic or hydrostatic servomotor and an electric servomotor (cf., U.S. Pat. No. 4,838,106) for actuating an output member of a steering gear and, therefore, for adjusting the steering angle of one or more steerable wheels of a vehicle.

Either the conventional power-steering systems require a disadvantageously large space, or the second servomotor is only situated in the steering systems for reasons of redundance and able to be switched on and off via a switchable coupling or, due to the type of construction (series-wound motor), may be overridden by the actuating torque at the steering handle and the torque of the first servomotor.

European Published Patent Application No. 1 167 161 describes a steering system for a vehicle, having a steering spindle that supports a steering handle on its one end. The other end of the steering spindle is connected to a first torsion element, which is connected, in turn, to a rotary slide valve or rotary piston of a steering valve for controlling a hydraulic servomotor. The hydraulic servomotor actuates an output member of a steering gear. In addition, an electric servomotor is redundantly provided for actuating the output member of the steering gear.

The availability of electric servomotors, which, for reasons of redundance, are held in reserve in a power-steering system as described in European Published Patent Application No. 1 167 161, is not reliably ensured. Furthermore, such steering systems are designed for the functioning of a single servomotor, which means that they are not optimized with regard to cost.

### SUMMARY

Example embodiments of the present invention may provide a vehicle steering system, whose hydraulic servomotor is permanently assisted both mechanically and electrically during operation, and which may be fail-safe and may render possible a tracking or lane-keeping mode.

Since the electric servomotor and the steering spindle of the steering system act upon a common rotating member, such as on an output shaft having a worm wheel upon which a worm of the electric servomotor acts, and since the common rotating member is arranged between the steering spindle or the first torsion element and the rotary slide valve or the rotary piston of the steering valve, the steering valve may be jointly controlled by the steering handle and by the electric servomotor, and the hydraulic servomotor and the output member of the steering gear may be actuated. The electric servomotor may be controlled as a function of, e.g., the rotational angle measured at the first torsion element, in order to output an equidirectional servomotor torque that assists the actuating torque at the steering handle.

If the electric servomotor and its motor control unit are operational, then the electric servomotor acts simultaneously upon, and in the same direction as, the hydraulic servomotor, so that it supports and also controls its motor torque applied to the output member of the steering gear. An open-loop and/or closed-loop control device of the steering system or of the vehicle controls the electric servomotor via signals of an angle-of-rotation sensor, which measures the torsion or rotation of the first torsion element or torsion bar due to actuating torques in the steering spindle.

The rotary slide valve or rotary piston of the steering valve is mounted to the common rotating member in a rotatably fixed manner. The other axial end of the rotary slide valve or rotary piston is connected by a second torsion element or torsion bar to a worm or screw, which engages with a working piston of the hydraulic servomotor. The working piston is axially displaced by both the rotation of the worm or screw and a flow of pressurized media into working chambers on both sides of the working piston, controlled by the rotary slide valve or rotary piston. In this context, the rotary slide valve interacts, via control channels, with a valve sleeve, with respect to which it may rotate in a limited manner. The output member of the steering gear is moved in this manner, a steering angle of one or more wheels of the vehicle being able to be changed via known kinematic connections.

The common rotating member may be connected to the rotary slide valve or the rotary piston of the steering valve by a coupling. The steering system renders possible a driver-assistance mode or an automatic mode, in that the electric servomotor is controlled by the open-loop and/or closed-loop control device as a function of parameters and the common rotating member and the rotary slide valve or rotary piston of the steering valve is rotated relative to the valve sleeve. In this manner, an exclusively servomotive drive is provided by the electric and hydraulic, e.g., hydrostatic, servomotor.

In case of breakdown of the hydraulic servomotor, the torques at the steering spindle, and of the electric servomotor, rotate the worm or screw in the working piston of the hydraulic servomotor and move the output member of the steering gear.

Particularly in the case of a malfunction of the electric servomotor, it may also be provided to arrange the worm gear or helical gear between the electric servomotor and the common rotating member to be able to be overridden by the actuating torque at the steering spindle. In order to arrange the steering system to be compact, it may be provided to fix a housing of the electric servomotor to a housing of the steering gear. The second torsion element connected to the screw in the working piston of the hydraulic servomotor is manufactured to be considerably more torsionally stiff that the first torsion element.

Instead of arranging the steering gear along the lines of a hydraulic, ball-and-nut power-steering system, it may be provided to arrange the hydraulic servomotor as an actuator for a hydraulically assisted rack-and-pinion steering system, in order to assist the translational movement of a rack or a spindle. In addition to use in a passenger car, the steering system may be suitable for use in a commercial motor vehicle.

The steering spindle is detachably mounted to an input shaft of a steering actuator in a form-locked manner, the steering actuator integrating the electric servomotor with its worm gear or helical gears, the common rotating member and its coupling to the rotary slide valve or rotary piston, the steering valve and the first and second torsion elements and the hydraulic servomotor, and, e.g., also the open-loop and/or closed-loop control device for the electric servomotor, together with the steering gear, into one unit in the described manner.

Example embodiments of the present invention are described in more detail below with reference to the appended Figure.

### BRIEF DESCRIPTION OF THE DRAWING

FIG. 1 is a partial longitudinal cross-sectional view of a steering system according to an example embodiment of the present invention.

### DETAILED DESCRIPTION

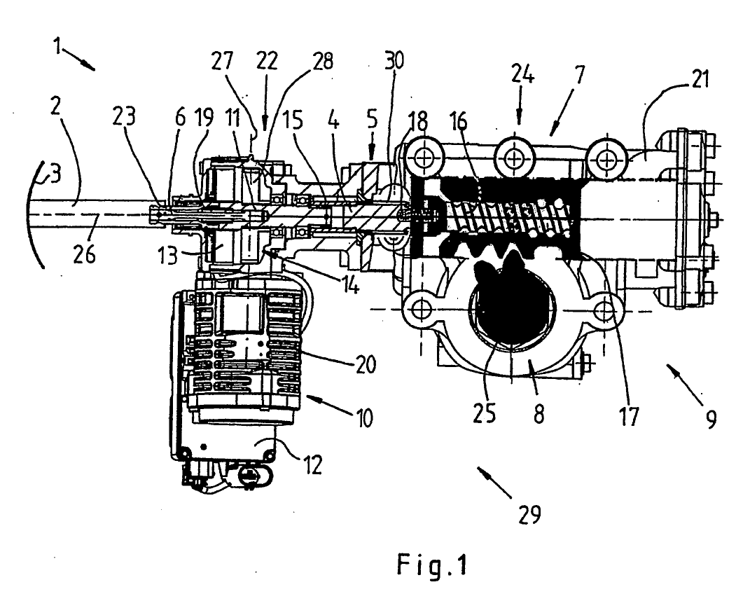

In FIG. 1, a steering system 1 is illustrated in a partial longitudinal cross-sectional view of a geared connection 22 between an input shaft 23 of a steering spindle 2 at a steering actuator 29, an electric servomotor 10, and a hydraulic, recirculating ball-and-nut steering unit 24.

Steering system 1 is intended for installation in a commercial vehicle, but may be used, e.g., in all types of vehicles or motor vehicles. Steering system 1 allows an output member 8 of a steering gear 9 to be parallelly and simultaneously actuated by steering spindle 2, electric servomotor 10, and by a hydraulic servomotor 7 of recirculating ball-and-nut steering unit 24. Output member 8 takes the form of a steering shaft 25 for actuating a steering-gear arm. Steering system 1 also allows operation and actuation of output member 8 in the event of failure of electric servomotor 10 or hydraulic servomotor 7, as well as automatic, controlled operation by electric servomotor 10 without application of an actuating torque to steering handle 3 and steering spindle 2.

Steering system 1 has a longitudinal axis 26, on which the components of steering system 1 are functionally arranged one after another in series. A steering handle 3 is connected to steering spindle 2 in a rotatably fixed manner. Steering spindle 2 is connected to input shaft 23 in a detachably form-locked, rotatably fixed manner. Via a first torsion element 6 that takes the form of a torsion bar, input shaft 23 is operably connected to a common rotating member 11 that takes the form of a shaft. Electric servomotor 10 is arranged in the axial region of first torsion element 6, with its longitudinal axis 27 perpendicular to longitudinal axis 26 of steering system 1. Electric servomotor 10 drives common rotating member 11 via a worm gear 14, which includes a worm on its motor shaft and a worm wheel 28 fixed to common rotating member 11. This occurs according to an open-loop and/or closed-loop control device 12, which processes signals of an angle-of-rotation or torque sensor 13 measuring the torsion of first torsion element 6.

Common rotating member 11 is connected to a rotary slide valve 4 of steering valve 5 in a rotatably fixed manner, via a coupling 15. Rotary slide valve 4 interacts with a valve sleeve 30 of steering valve 5, e.g., in a conventional manner, via control channels, the deflection of rotary slide valve 4 with respect to valve sleeve 30 being limited by a transverse pin at a transverse bore hole of rotary slide valve 4. Rotary slide valve 4 controls a flow of pressurized media into working chambers of a cylinder of hydraulic servomotor 7, by which an axial displacement of a working piston 17 of hydraulic servomotor 7 is produced. Hydraulic servomotor 7 and its geared connection to output member 8, i.e., gear teeth, are integrated in a housing 21 of steering gear 9. A screw 16 engages with working piston 17, the rotation of screw 16 setting working piston 17 into axial motion via a recirculating ball element. Screw 16 is fastened to rotary slide valve 4 of steering valve 5 in a rotatably fixed manner by a second torsion element 18, which is-considerably more rigid than first torsion element 6. The torsion or rotation of second torsion element 18 controls the supply of pressurized media to the working chambers of the hydraulic cylinder.

Electric servomotor 10 is fastened by its housing 20 to housing 21 of steering gear 9 and forms, together with it, steering actuator 29, the housing of the electric servomotor enclosing open-loop and/or closed-loop control device 12.

In an automatic tracking or lane-keeping mode of steering system 1, common rotating member 11 is actuated by electric servomotor 10, which controls the flow of pressurized media into the working chambers of the hydraulic cylinder via the torsion of second torsion element 18 and via rotary slide valve 4, and axially moves working piston 17 in a mechanical manner via screw 16. If hydraulic servomotor 7 malfunctions, output member 8 of steering gear 9, and therefore working piston 17, are actuated by the actuating torque at steering handle 3, acting upon common rotating member 11, and/or by the motor torque of electric servomotor 10. In this context, first torsion element 6 may be protected from excess stress, e.g., when electric servomotor 10 should fail, in that a driving element 19 bypasses first torsion element 6 between steering spindle 2 and common rotating member 11.

| | |
|---|---|
| 1 | steering system |
| 2 | steering spindle |
| 3 | steering handle |
| 4 | rotary slide valve, rotary piston |
| 5 | steering valve |
| 6 | first torsion element |
| 7 | hydraulic servomotor |
| 8 | output member |
| 9 | steering gear |
| 10 | electric servomotor |
| 11 | rotating member |
| 12 | open-loop and/or closed-loop control device |
| 13 | angle-of-rotation sensor |
| 14 | helical-worm gear |
| 15 | coupling |
| 16 | screw |
| 17 | working piston |
| 18 | second torsion element |
| 19 | driving element |
| 20 | housing of 10 |
| 21 | housing of 9 |
| 22 | geared connection |
| 23 | input shaft |
| 24 | recirculating ball-and-nut steering unit |
| 25 | steering shaft |
| 26 | longitudinal axis of 1 |
| 27 | longitudinal axis of 10 |
| 28 | worm wheel |
| 29 | steering actuator |
| 30 | |
| 31 | |
| 32 | |
| 33 | |
| 34 | |
| 35 | |
| 36 | |
| 37 | |
| 38 | |
| 39 | |
| 40 | |
| 41 | |
| 42 | |
| 43 | |
| 44 | |
| 45 | |
| 46 | |
| 47 | |
| 48 | |
| 49 | |
| 50 | |

1-16. (canceled)

17. A steering system for a vehicle, comprising:
a steering spindle connecting a steering handle on one end to one of (a) a rotary slide valve and (b) a rotary piston of a steering valve by a first torsion element;
a hydraulic servomotor adapted to actuate an output member of a steering gear, a flow of pressurized media into working chambers of the hydraulic servomotor controllable by the steering valve; and
an electric servomotor adapted to actuate the output member;
wherein the electric servomotor and the steering spindle are adapted to act upon a common rotatable member between the first torsion element and the one of (a) the rotary slide valve and (b) the rotary piston.

18. The steering system according to claim 17, wherein the steering system is arranged as a hydraulic power-steering system for a motor vehicle.

19. The steering system according to claim 17, wherein the electric servomotor and the hydraulic servomotor are adapted to simultaneously act upon the output member of the steering gear during operation of the steering system.

20. The steering system according to claim 17, wherein the electric servomotor is controllable by at least one of (a) an open-loop and (b) a closed-loop control device of one of (a) the steering system and (b) the vehicle as a function of signals of an angle-of-rotation sensor adapted to measure at least one of (a) an angle of rotation and (b) an actuating torque at the steering handle.

21. The steering system according to claim 17, wherein the electric servomotor is adapted to act upon the common rotatable member by one of (a) a helical and (b) a worm gear.

22. The steering system according to claim 17, wherein the common rotatable member is connected to the one of (a) the rotary slide valve and (b) the rotary piston of the steering valve by a coupling.

23. The steering system according to claim 17, wherein the hydraulic servomotor includes a working piston actuatable by a screw, the screw connected to the one of (a) the rotary slide valve and (b) the rotary piston of the steering valve in a rotatably fixed manner by a second torsion element.

24. The steering system according to claim 23, wherein the flow of pressurized media into the working chambers of the hydraulic servomotor is controllable as a function of torsion of the second torsion element.

25. The steering system according to claim 17, wherein the electric servomotor is adapted to exclusively actuate the common rotatable member in at least one of (a) an automatic tracking mode of the steering system and (b) a driver-assistance mode of the steering system.

26. The steering system according to claim 17, wherein the steering spindle and the electric servomotor are adapted to actuate the output member of the steering system in an event of a failure of the hydraulic servomotor.

27. The steering system according to claim 17, wherein at least one of (a) the electric servomotor and (b) at least one of (i) a worm gear and (ii) a helical gear between the electric servomotor and the common rotatable member are overridable by manipulation of the steering handle.

28. The steering system according to claim 17, wherein the steering valve and the hydraulic servomotor are acuatable by the steering handle in an event of failure of the electric servomotor, the first torsion element bypassed by a driving element between the steering spindle and the common rotatable member.

29. The steering system according to claim 17, wherein a housing of the electric servomotor is fixed to a housing of the steering gear.

30. The steering system according to claim 23, wherein the second torsion element is torsionally stiffer than the first torsion element.

31. The steering system according to claim 17, wherein the hydraulic servomotor is arranged in a hydraulically assisted rack-and-pinion steering system.

32. The steering system according to claim 17, wherein the steering system is arranged in a commercial vehicle.

33. The steering system according to claim 23, wherein the electric servomotor, the common rotatable member, the hydraulic servomotor, the first torsion element, the second torsion element, the steering valve and the output member are integrated in a steering actuator.
